(19) United States
(12) Patent Application Publication
(10) Pub. No.: US 2007/0151519 A1
(43) Pub. Date: Jul. 5, 2007

(54) Device for distributing fish feed

(76) Inventor: Rune Haug, Rorvik (NO)

Correspondence Address: James E Bradley;Bracewell & Giuliani, P O Box 61389, Houston, TX, 77208-1389, US

(21) Appl. No.: 10/551,850

(22) PCT Filed: Apr. 1, 2004
(86) PCT No.: PCT/NO04/00095

§ 371 Date: Nov. 27, 2006

(30) Foreign Application Priority Data
Apr. 2, 2003 (NO) 20031504

(51) Int. Cl. A01K 61/02

(52) U.S. Cl. 119/51.04; 119/230

(57) ABSTRACT

A device for distributing fish feed to multiple fish receptacles in a fish farming plant, with at least one fish feed tank (12-16). The feed tank has several outlets (17-19) with a pump (21,22,23) and a conduit (24) connected to each outlet for transport of fish feed to the fish receptacles. Each pump (21-23) is individually controllable. The conduits (24) from the pumps (21-23) are connected to a connector assembly (25-27) at the exterior (28) of the device. The connector assembly has several outlets, each outlet communicating with one of the fish receptacles. A multiple valve (30) acts as the connector assembly.

The present invention relates to a device as stated in the introduction to claim 1, for distributing fish feed from one or more storage tanks to a plurality of fish receptacles for fish farming. “Fish receptacle” may include any means for containing fish and similar marine organisms for rearing, including net cages, ponds, or any other fish container in water, on a vessel or on land. The invention also comprises a novel multiple valve for expanding the capacity of a device according to the invention.

### BACKGROUND OF THE INVENTION

The expansion of fish farming, demanding distribution of fish feed to multiple fish receptacles including net cages and stationary ponds, has created a requirement for more efficient distribution of feed.

Research has shown that the fish will make more efficient use of the feed, when received and absorbed during the daylight time. For fish farming in the northern and southern part of the hemispheres, this will shorten the time available for distribution of feed in which the feed can be efficiently digested. Even a low gain in percentage of digested feed can give a large gain in the profit.

From Norwegian patent publication 179351 (Sørskår) it is known a distribution system feeding a multiple of net cages with one single conduit or tube connecting the net cages in a series. For each net cage a valve assembly is provided, which can be controlled for feeding the net cages one after another.

In addition to requiring a multiple of costly valve assemblies, the serial feeding is time consuming. The control system and the equipment needed for this distribution system adds to the costs, both in installment and maintenance.

From Norwegian patent 312931 (Feeding Systems) it is known a feed distribution system with a storage container having two feed distribution valves, provided for distributing feed to two net cages simultaneously. This system has also severe capacity limitations.

A common disadvantage of both prior art distribution system is the failure in combining a rapid distribution with control of the supply of feed to the individual fish receptacles.

### OBJECT OF THE INVENTION

The main object of the invention is to provide a device for distributing fish feed from one or more storage tanks to a plurality of fish receptacles for fish fanning simultaneously, which has a higher efficiency that prior art devices. A particular object is to provide a device which can distribute a certain quantity of feed within a short period of time, to a multitude of fish receptacles, the device having least possible movable part and a simple control system.

Further, it is an object to provide a device with downsized conduits, maintaining the capacity needed for efficient distribution.

Finally, it is an object to provide a simple and reliable multiple valve for expanding the capacity of the fish feed distribution device.

### THE INVENTION

The invention is defined in claim 1. In claim 3, a multiple valve suitable for use with the device according to claim 1 is described. The remaining subclaims state further features of the invention.

The device according to the invention provides an improved means for distributing fish feed to several fish receptacles in a short time and with maximum flexibility in regard of supplying fish feed to the individual fish receptacles.

### EXAMPLES

In the following, embodiments of the invention will be described with reference to the drawings, where

FIG. 1 shows a side view partly in section of a vessel for transport, storage and distribution of fish feed,

FIG. 2 shows a sectional plan view of the vessel in FIG. 1, and

FIG. 3 shows a sectional view of a part of a multiple valve device for expanding the capacity of the device according to the invention.

In FIGS. 1 and 2 a vessel 11 for transport, storage and distribution of fish feed is shown, comprising five storage tanks 12, 13, 14, 15, 16 arranged lengthwise on the vessel. Each storage tank 12-16 has a triple outlet 17, 18, 19 at the bottom of a hopper bottom 20, each outlet being connected to a pump 21, 22, 23. Thus, the vessel 11 will have a total of 15 pumps, each with a conduit 24 leading to one of three connection assemblies 25, 26, 27 at one end of the vessel 11, arranged in a partition wall 28.

The connector assemblies 25-27 each comprises five connectors 29 for releasably connecting the in-vessel conduits 24 to an external series of conduits extending to one of several fish receptacles for distribution of fish feed thereto.

The connectors 29 may be any convenient tube connector. In this embodiment, the pumps 21-23 will act as a valve and as transport mean and also as a control means, as each pump may be controlled individually in regard of time of operation and capacity of output.

This device will have a capacity corresponding to the number of pumps available. To expand the number of output conduits, a manual change of the connectors of the connectors 29 is necessary, which however is inconvenient.

Each of the three connector assemblies 25-27 may also comprise a multiple valve, with double or triple outlets, which will double or triple the maximum number of fish receptacles serviceable, without imparing the capacity notably and without loss of individual control.

In FIG. 3, a part of a novel multiple valve 30 is shown, which can combine the object of expanding the capacity of the distribution device and providing a connector allowing the releasing of the main part of the fish feed distribution device from the tubing arranged in the area of the fish receptacles, e.g. the net cages.

A basic element in the shown multiple valve, is a carrier plate 31 which is provided with two parallel rows of outlet openings 32, 33. The carrier plate 31 may be mounted in a partition wall or an outer wall 34 of the distribution device for which it is intended.

The parallel rows of outlet openings 32, 33 have a mutual axial distance of at least two times the diameter of an outlet opening 32, 33. In each opening a pipe socket 35, 36 is shrink fit, with the socket extending to the rear of the carrier plate 31 for connection to a conduit leading to a fish receptacle

On the front side of the multiple valve carrier plate 31, a rectangular slide plate 37 is arranged to be movable in a direction perpendicular to the direction of the rows of outlet openings 32, 33. The slide plate 37 has a row of inlet openings 38 parallel to the rows of outlet openings 32, 33 and with the same distance between neighbouring openings in the row.

For each inlet opening 38 an inlet pipe socket 39 is shrink fit into each of the inlet opening. At the free end of the inlet pipe sockets 39, a pair of radial lugs 40, 41 are arranged on opposite sides for the attachment of a conduit, which can be a hose or tube, connecting the inlet opening 38 to a storage tank outlet. The inlet pipe socket 39 has an inner recess 42 at the end. The pipe sockets 35, 36 and 39 can be fasten in other suitable ways.

At each outlet opening 32, 23 an annular groove 43 is arranged concentric to the opening, facing the slide plate 37. In this groove 43 an annular gasket 44 is arranged. The annular gasket 44 may be of a polymer or rubber and it is projecting from the multiple valve carrier plate 31 for bridging any gap between the multiple valve carrier plate 31 and the slide plate 37.

The number of inlet openings 38 corresponds to the number of pumps 21-23. The number out outlet openings 32, 33 corresponds to the number of fish receptacles to be supplied with fish feed. In the case of a fish farming plant with e.g. 30 fish receptacles, and the use of a multiple valve as shown in the above embodiment, the number of outlet openings 32, 33 in each row and the number of inlet openings 38 may be fifteen. Thus, with a multiple valve with this capacity, fifteen fish receptacles can be provided with fish feed simultaneously, and fifteen further receptacles in an additional feeding sequence.

The connector assemblies 25-27 may be arranged in other positions on the vessel, including the opposite end. One may also contemplate multiple valves with more than two rows of outlet openings.

1. A device for distributing fish feed to multiple fish receptacles in a fish farming plant comprising:
at least one fish feed tank (12-16) having a plurality of outlets (17-19);
an individually controllable pump (21-23) arranged at each of the outlets (17-19) for fish feed; and
a conduit (24) extending from each of the pumps (21-23), each of the conduits being connected to a connector assembly (25-27) at the exterior (28) of the device, for communicating with each fish receptacle.

2. A device according to claim 1, wherein the pumps (21-23) are arranged, to be individually controlled for supplying the fish receptacles with individually determined quantities of fish feed.

3. The device according to claim 1, further comprising:
a multiple valve (30) having a stationary part (31) with at least two parallel rows of outlet openings (32) and a movable part (37) with a row of inlet openings (38), the moveable part (37) being movable between an open and a closed position relative to the openings in the stationary part;
the rows of outlet openings being perpendicular to the direction of movement of the moveable part (37), each outlet opening (32, 33) having a pipe socket (39) for connection to a. conduit supplying fish feed to a fish receptacle; and
the movable part (37) being a plate (37) containing the row of inlet openings (38) that corresponds with the rows of outlet openings (32, 33), the movable plate being arranged for
the rows of outlet openings being perpendicular to the direction of movement of the moveable part (37), each outlet opening (32, 33) having a pipe socket (39) for connection to a. conduit supplying fish feed to a fish receptacle; and
the movable part (37) being a plate (37) containing the row of inlet openings (38) that corresponds with the rows of outlet openings (32, 33), the movable plate being arranged for sliding movement on the stationary part (31) between a position wherein one of the rows of outlet openings is aligned with the corresponding openings in the row of inlet openings, and a position in which the openings in the openings in the other row of outlet openings are aligned with the corresponding openings in the row of inlet openings.

4. The device according to claims 3, wherein each of the inlet openings (38) has a tube pipe socket (39), each tube pipe socket being connected to one of the conduits leading to a pone of the pumps.
